(19) United States
(12) Patent Application Publication
(10) Pub. No.: US 2019/0025402 A1
(43) Pub. Date: Jan. 24, 2019

(54) DETECTION AND LOCATION OF A MOBILE DEVICE USING SOUND

(71) Applicant: Driving Management Systems, Inc., San Francisco, CA (US)

(72) Inventors: Peter Qu, San Francisco, CA (US); Marwan Hannon, San Francisco, CA (US); Michael J. McCallen, Ottawa (CA)

(21) Appl. No.: 16/041,716

(22) Filed: Jul. 20, 2018

Related U.S. Application Data
(60) Provisional application No. 62/535,067, filed on Jul. 20, 2017.

(51) Int. Cl. G01S 5/30; H04M 1/725; H04W 4/48; G01S 11/14

(52) U.S. Cl. CPC G01S 5/30; G01S 11/14; H04W 4/48; H04M 1/72577

(57) ABSTRACT

A method for determining the location of a mobile device in a vehicle may include the transmission by one or more speakers of the vehicle of a sound signal having predetermined characteristics. The mobile device may include the capability to recognize the sound signal based on methods to identify a sound signal having the predetermined characteristics. In some aspects, the mobile device may incorporate software having a specific filter that is matched to the characteristics of the sound signal transmitted by the speakers. The mobile device may also include software configured to disambiguate effects of multi-path scattering, reflection, and attenuation of the signal through the vehicle cabin. The vehicle may include software to generate the sound signal and to adjust the sound signal characteristics for position-dependent signal fading, frequency dependent signal fading, and high amplitude audio interference.

### CROSS-REFERENCE TO RELATED APPLICATIONS

This application claims priority under 35 U.S.C. § 119 to U.S. Provisional Patent Application No. 62/535,067, filed Jul. 20, 2017, and titled “DETECTION AND LOCATION OF A MOBILE DEVICE USING SOUND,” which is hereby incorporated by reference herein in its entirety and for all purposes.

### BACKGROUND

Mobile devices such as wireless devices, including, for example, cellular telephones, smart phones, laptop computers, notebook computers, tablet devices (e.g., iPad by Apple®) are ubiquitous in modern society. Use of such mobile devices while operating a vehicle, however, can be hazardous. The problem is exacerbated for inexperienced operators of the vehicle, such as those just learning how to drive. Rates of vehicular accidents where mobile devices are involved are rising, especially with teenagers. Text messaging while operating a moving vehicle can be dangerous and has been linked with causing accidents. More generally, operating any keyboard while operating a vehicle can be dangerous. It may be understood that mobile devices as disclosed herein may include any one or more easily transported and wireless-connectable devices including, but not limited to, cell phone, smart phones, notebook computers, laptop computers, tablet computers, smart watches, and any easily transported device that may be characterized as belonging to the Internet of Things (IoT).

Thus, the widespread adoption of mobile devices and common use of the devices while driving has raised concerns about the distraction of drivers. A driver speaking or text messaging on a mobile telephone may become mentally distracted from driving and lose control of the vehicle that he or she is driving. Thus, it is not uncommon to see an individual involved in an accident who was speaking or text messaging on a mobile device rather than paying attention to the road. Studies now suggest that individuals speaking on mobile telephones while driving a car may be as impaired as a person who drives while intoxicated. Not only is the driver mentally distracted, but eyes of the driver are diverted for dialing or looking to see who an incoming call is from.

It would be highly desirable to detect the presence of a mobile device, such as a wireless device, within a vehicle and to determine if the mobile device is located with the driver of the vehicle or with a passenger. In some aspects, it would be desirable for systems and methods to be employed that may then restrict the operation of a mobile device determined to be located at the driver location of the vehicle. In other aspects, it would be desirable for systems and methods to be employed that may control the operation of a mobile device determined to be located at a passenger or other location of the vehicle.

### SUMMARY

In an aspect, a system for determining a presence of a mobile device located in a predetermined detection zone within a vehicle may include: a plurality of transmitters located within the vehicle, in which each of the plurality of transmitters is configured to transmit a ranging acoustic signal that includes at least one predetermined ranging acoustic signal characteristic, a mobile device configured to receive each ranging acoustic signal transmitted by the plurality of transmitters, and a processor. The processor may be configured to determine a location of the mobile device within the vehicle based on the ranging acoustic signals transmitted by the plurality of transmitters and received by the mobile device, determine when the location of the mobile device matches the predetermined detection zone, and cause the mobile device to inhibit at least one function of the mobile device upon determining that the location of the mobile device matches the predetermined detection zone. The mobile device may be configured to identify the ranging acoustic signal based at least in part on the at least one predetermined ranging acoustic signal characteristic.

In one aspect of the system, the predetermined detection zone is a three dimensional area at, around, or proximal to a driver's side or seat of a vehicle.

In one aspect of the system, the predetermined detection zone is a three dimensional area at or near a passenger seat.

In one aspect of the system, the ranging acoustic signal includes a linear chirp signal.

In one aspect of the system, the ranging acoustic signal includes a non-linear chirp signal.

In one aspect of the system, the mobile device is configured to identify the ranging acoustic signal using a matching filter.

In an aspect, a method for determining a presence of a mobile device located in a predetermined detection zone within a vehicle may include transmitting, by each of a plurality of transmitters located within the vehicle, a ranging acoustic signal to the mobile device, in which the ranging acoustic signal includes at least one predetermined ranging acoustic signal characteristic, receiving, by the mobile device, each ranging acoustic signal transmitted by the plurality of transmitters, identifying, by the mobile device, each ranging acoustic signal according to the at least one predetermined ranging acoustic signal characteristic, determining, by a processor, a location of the mobile device within the vehicle based on the ranging acoustic signals transmitted by the plurality of transmitters and received by the mobile device when the ranging acoustic signals are identified by the mobile device as having the at least one predetermined ranging acoustic signal characteristic, and determining that the location of the mobile device matches the predetermined detection zone.

In one aspect, the method further includes inhibiting at least one function of the mobile device upon determining that the location of the mobile device matches the predetermined detection zone, in which the predetermined detection zone is a three dimensional area at, around, or proximal to a driver's side or seat of a vehicle, and in which each of the ranging acoustic signals comprises at least one ultrasonic pulse having a frequency in a range of 16 KHz to 26 KHz.

In one aspect, the method further includes inhibiting at least one function of the mobile device upon determining that the location of the mobile device matches the predetermined detection zone, in which the predetermined detection zone is a three dimensional area at, around, or proximal to a driver's side or seat of a vehicle, and in which each of the ranging acoustic signals comprises at least one ultrasonic pulse at 19 kHz.

In one aspect of the method, transmitting a ranging acoustic signal to the mobile device, in which the ranging acoustic signal comprises at least one predetermined ranging acoustic signal characteristic is composed of transmitting a ranging acoustic signal to the mobile device, in which the ranging acoustic signal includes a linear chirp signal.

In one aspect of the method, transmitting a ranging acoustic signal to the mobile device, in which the ranging acoustic signal comprises at least one predetermined ranging acoustic signal characteristic is composed of transmitting a ranging acoustic signal to the mobile device, in which the ranging acoustic signal includes a non-linear chirp signal.

In one aspect of the method, identifying, by the mobile device, each ranging acoustic signal according to the at least one predetermined ranging acoustic signal characteristic is composed of filtering, by the mobile device, each ranging acoustic signal according to a filter having filter characteristics that match the at least one predetermined ranging acoustic signal characteristic.

In an aspect, a method of controlling the use of a software application by a user of a mobile device located within a vehicle may include configuring the mobile device to permit or restrict the use of the software application by the user when the mobile device is located within a pre-determined detection zone within the vehicle, transmitting, by each of a plurality of transmitters located within the vehicle, a ranging acoustic signal to the mobile device, in which the ranging acoustic signal includes at least one predetermined ranging acoustic signal characteristic, receiving, by the mobile device, each ranging acoustic signal transmitted by the plurality of transmitters, identifying, by the mobile device, each ranging acoustic signal according to the at least one predetermined ranging acoustic signal characteristic, determining, by a processor, a location of the mobile device within the vehicle based on the ranging acoustic signals transmitted by the plurality of transmitters and received by the mobile device when the ranging acoustic signals are identified by the mobile device as having the at least one predetermined ranging acoustic signal characteristic, determining that the location of the mobile device matches the predetermined detection zone, and permitting or restricting the use of the software application by the user when the location of the mobile device matches the pre-determined detection zone.

In one aspect of the method, configuring the mobile device to permit or restrict the use of the software application by the user includes configuring the mobile device to permit or restrict the use of one or more of a telephone application, a texting application, a web browser application, a video streaming application, a video conferencing application, and a navigation application.

In one aspect of the method, configuring the mobile device to permit or restrict the use of the software application by the user when the mobile device is located within a pre-determined detection zone within the vehicle includes configuring the mobile device to restrict the use of the software application by the user when the mobile device is located within a pre-determined detection zone that includes a three dimensional area surrounding or proximate to the driver's seat in the vehicle, and in which permitting or restricting the use of the software application by the user when the location of the mobile device matches the pre-determined detection zone includes restricting the use of the software application by the user when the location of the mobile device matches the pre-determined detection zone composed of a three dimensional area surrounding or proximate to the driver's seat in the vehicle.

In one aspect of the method, configuring the mobile device to permit or restrict the use of the software application by the user when the mobile device is located within a pre-determined detection zone within the vehicle includes configuring the mobile device to permit the use of the software application by the user when the mobile device is located within a pre-determined detection zone composed of a three dimensional area surrounding or proximate to a passenger's seat in the vehicle, and in which permitting or restricting the use of the software application by the user when the location of the mobile device matches the pre-determined detection zone includes permitting the use of the software application by the user when the location of the mobile device matches the pre-determined detection zone composed of a three dimensional area surrounding or proximate to the passenger's seat in the vehicle.

In one aspect of the method, configuring the mobile device to permit or restrict the use of the software application by the user includes configuring the mobile device to permit or restrict the use of the software application by entering configuration data through a graphical user interface displayed on the mobile device.

In one aspect of the method, configuring the mobile device to permit or restrict the use of the software application by entering configuration data through a graphical user interface displayed on the mobile device includes configuring the mobile device to permit or restrict the use of the software application by entering configuration data through a graphical user interface displayed on the mobile device by one or more individuals having appropriate programming privileges.

In one aspect of the method, configuring the mobile device to permit or restrict the use of the software application by entering configuration data through a graphical user interface displayed on the mobile device includes configuring the mobile device to permit or restrict the use of the software application by entering configuration data through a graphical user interface displayed on the mobile device in which the graphical user interface includes indicia of one or more software applications and indicia of one or more zones within the vehicle.

### BRIEF DESCRIPTION OF THE FIGURES

The features of the various aspects are set forth with particularity in the appended claims. The various aspects, however, both as to organization and methods of operation, together with advantages thereof, may best be understood by reference to the following description, taken in conjunction with the accompanying drawings as follows:

FIG. 1 is a diagram of a system for determining a presence of a mobile device located in a predetermined detection zone according to an aspect of the present disclosure.

FIG. 2 is an illustration of a plurality of speakers installed inside of a vehicle according to one aspect of the present disclosure.

FIG. 3 is an illustration of a calculation process for determining a relative location of a mobile device according to an aspect of the present disclosure.

FIG. 4 is an amplitude versus time plot depicting an aspect of a recording of a signal received by a mobile device from a speaker according to an aspect of the present disclosure.

FIG. 5A is a plot of amplitude versus time of a portion of an acoustic ranging signal and a portion of the impulse response of a filter matched to the ranging acoustic signal according to an aspect of the present disclosure.

FIG. 5B is a plot of amplitude versus time of a signal recovered by applying the matching filter of FIG. 5A to the signal recorded by the mobile device depicted in FIG. 4 in which multipath disturbances are not found according to an aspect of the present disclosure.

FIG. 5C is a plot depicting s a plot of amplitude versus time of a signal recovered by applying the matching filter of FIG. 5A to the signal recorded by the mobile device depicted in FIG. 4 in which multipath disturbances are detected according to an aspect of the present disclosure.

FIGS. 6A,B depict a front face and a rear face, respectively, of one aspect of a mobile device illustrating the location of multiple microphones in that mobile device according to an aspect of the present disclosure.

FIGS. 7A,B depict a front face and a rear face, respectively, of a second aspect of a mobile device illustrating the location of multiple microphones in that mobile device according to an aspect of the present disclosure.

FIG. 8 depicts a screen-shot of one example of a mobile device control interface according to an aspect of the present disclosure.

### DETAILED DESCRIPTION

Various aspects are described to provide an overall understanding of the structure, function, manufacture, and use of the devices and methods disclosed herein. One or more examples of these aspects are illustrated in the accompanying drawings. Those of ordinary skill in the art will understand that the devices and methods specifically described herein and illustrated in the accompanying drawings are non-limiting aspects and that the scope of the various aspects is defined solely by the claims. The features illustrated or described in connection with one aspect may be combined, in whole or in part, with the features of other aspects. Such modifications and variations are intended to be included within the scope of the claims.

With the advancement of mobile technology, people have the capability to stay connected at all time. For many people, the urge to stay connected does not stop when they are behind the driving wheel. Driving while distracted by mobile technology is an endangerment to both the driver and general public. The present disclosure seeks to discourage distracted driving by partially inhibiting a function of a mobile device that might otherwise be used in a moving vehicle and in the proximity of the driver seat. This disclosure provides non-limiting descriptions regarding technology that detects whether the mobile device is on, near, or proximal to the driver seat. Additionally, this disclosure provides non-limiting descriptions regarding technology that detects whether the mobile device is on, near, or proximal to any one or more passenger seats. Additional control functions of a mobile device associated with the one or more passenger seats is also disclosed herein.

Many location detection technologies rely on two phenomena of physics: time of arrival of a signal and the received power of the signal. Time of arrival (TOA) is a location detection technique. If a distant transmitter emits a wave, and the receiver detects the wave at a later time, the distance between the transmitter and receiver is determined by the formula d=V*t, where V is the propagation velocity of the wave, and t is the time that the wave takes to arrive at the receiver. TOA detection has been used extensively with sound wave (such as sonar), because the relative slow speed of sound lends to high location detection accuracy. At normal temperature, pressure and humidity, sound wave travels about 340 meters per second, or approximately 1 foot per millisecond in normal atmosphere. Many animals and modern instruments are capable of measuring TOA with sufficient accuracy for good location detection. For example, some dolphins and bats are known to use ultrasonic echo to locate their prey. Additionally, submarines use sonar to detect enemy vessels. Further, backup sensors installed on vehicles use ultrasonic sonar to detect obstruction near the rear of the vehicle.

The use of TOA with electromagnetic wave is limited due to the high speed of the electromagnetic wave. All electromagnetic waves travel at speed of light, that is 3×10⁸ m/s, or approximately 1 foot per nanosecond. If sub-meter location accuracy is desired, then synchronization between transmitter and receiver and the measurement of TOA must have accuracy of sub-nanoseconds. The electronic systems capable of measuring to nanosecond resolution, or at high GHz frequency, are often expensive. In one example of TOA measurements of electromagnetic radiation is the Global Positioning System (GPS). The GPS partially circumvents the nanoseconds timing challenge by having multiples GPS satellites synchronized using atomic clocks, and then continuously sending GPS signal packets containing the time stamp from the satellites. The GPS receivers at the ground thus do not require high accuracy synchronization, but still have to measure relative delays between multiple GPS signals accurately. It is only within the recent decade that the cost of GPS receivers have came down dramatically, making GPS affordable to more consumers.

The power or signal strength of a wave may weaken as the receiver moves further away from the transmitter as a result of geometric dilution of the signal power. If the distance between the transmitter and receiver is R, then the power density sensed by the receiver is given by the equation below:

$${S}_{u} = \frac{{P}_{s}}{4 \cdot π \cdot {R}^{2}}$$

Where Sᵤ is the received power density and Pₛ is the power from the transmitter.

Many modern technologies make use of this phenomenon to perform distance detection. Radar is one of the most well known examples where a radar transmitter sends an electromagnetic wave, and measured the received power of the electromagnetic waves reflects off an object from the distance. In consumer electronic technology, various location detection techniques have been developed using Received Signal Strength (RSS) measurements of wireless signals such as cellular, Wifi and Bluetooth®. For example, the Wifi Positioning Technology promoted by Google®, Skyhook® and Navizon® uses measured RSS to known Wifi access points to determine the location of mobile devices (Skyhook®).

The received power approach to location detection may have limiting factors, which can include:
1) Signal noise: noise from various sources such as electronic (thermal, shot, flicker) can degrade the accuracy of the measured RSS;
2) Interference: reflection and refraction of the wave can lead to less accurate measurement. In addition, if more than one transmitter shares the same frequency spectrum, then the crowding effect further degrades RSS measurement; and
3) Obstruction: if there is any obstruction between the transmitter and receiver, then the received power is no longer solely dependent on the distance, but also the extent of the obstruction.

In one aspect, a system including hardware and software, uses the TOA of high frequency sound waves (such as, for example, 19 KHz) for driver side location detection of a mobile device. In one aspect, the present disclosure includes software that functions as an application that can be installed on mobile devices, such as a smartphone or a tablet. In some examples, the hardware related to the system may be installed in the vehicle and may include one or more microphones, speakers, and electronic devices such as an embedded processor. The present disclosure provides a method of mobile device detection in which an audio signal emitted by multiple speakers installed in a car is detected by a mobile device.

The present disclosure describes aspects of an apparatus, system, and method for detecting the presence of a mobile device, such as a wireless device, in a predetermined detection zone and controlling or inhibiting operation of the mobile device when it is detected in the predetermined detection zone. In particular, the present disclosure is directed to aspects of an apparatus, system, and method for detecting the presence of a mobile device such as a wireless device in a predetermined detection zone within a vehicle and disabling some or all of the functions of the mobile device when it is detected in the predetermined detection zone. In some aspects, the predetermined detection zone may be a three dimensional area at, around, or proximal to a driver's side or seat of a vehicle. More particularly, the present disclosure is directed to automatically preventing a person in the driver's seat of a vehicle from text messaging and doing other similar activities using a mobile device, especially while the vehicle is active and/or moving.

It is to be understood that this disclosure is not limited to particular aspects or aspects described, as such may vary. It is also to be understood that the terminology used herein is for the purpose of describing particular aspects or aspects only, and is not intended to be limiting, since the scope of the apparatus, system, and method for detecting the presence of a mobile device within a predetermined zone within a vehicle and controlling the operation of the mobile device when it is detected is defined only by the appended claims.

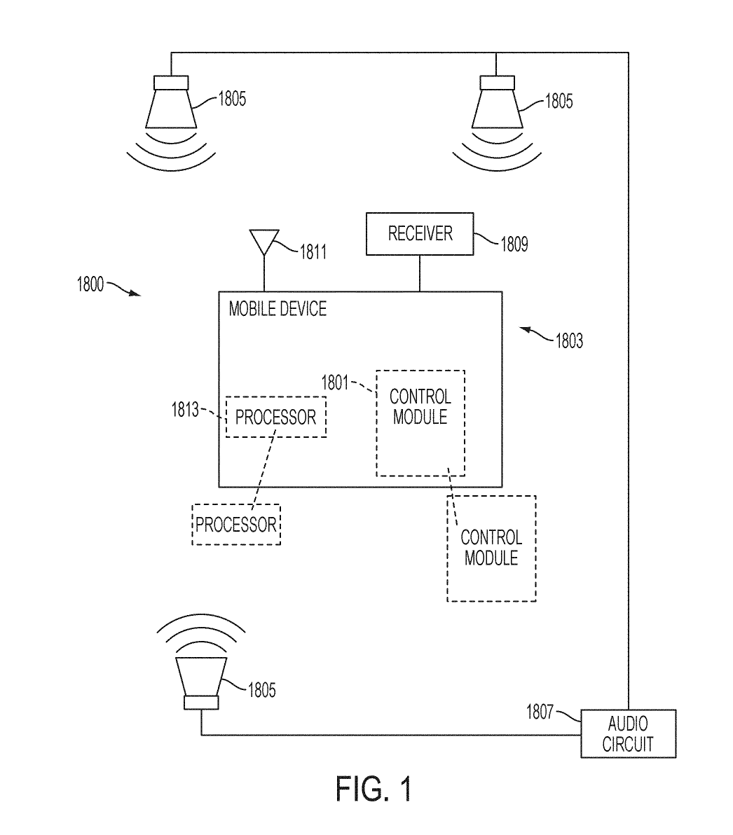

As shown in FIG. 1, in one aspect of the present disclosure, which may be referred to as passive detection, a system 1800 for determining a presence of a mobile device located in a predetermined detection zone includes a plurality of transmitters 1805, where each of the plurality of transmitters 1805 is configured to transmit one or more ranging acoustic signals. In some examples, the transmitters may be disposed at various locations within the vehicle. In some examples, the transmitters may be disposed on or within a front dashboard of the vehicle. In other examples, the transmitters may be disposed on or within one or more interior door panels of the vehicle. In some other examples, the transmitters may be located on or within a compartment located in the rear of the vehicle cabin compartment. It may be recognized that the transmitters may be located at or within any of the areas of the vehicles as disclosed above or at or in any alternative interior locations within the vehicle cabin.

The system 1800 may also include a mobile device 1803 configured to receive each of the one or more ranging acoustic signals transmitted by the plurality of transmitters 1805. The system 1800 may also include a processor 1813 configured to determine a location of the mobile device 1803 based on the ranging acoustic signals transmitted by the plurality of transmitters 1805 and received by the mobile device 1803 and to determine whether the location of the mobile device 1803 matches the predetermined detection zone. The processor 1813 may also be configured to cause the mobile device 1803 to inhibit at least one function of the mobile device 1803 upon determining that the location of the mobile device 1803 matches the predetermined detection zone.

In aspects, the system 1800 may use the Time of Arrival (TOA) of each of the one or more ranging acoustic signals for detection of the mobile device 1803 and to determine whether the mobile device 1803 is in a driver side location of a vehicle. The one or more ranging acoustic signals may include at least one sonic pulse, which may be an ultrasonic pulse. In one aspect, the at least one ultrasonic pulse may have a primary frequency component in a range of about 15 KHz to about 26 KHz. In another aspect, the at least one ultrasonic pulse may have a primary frequency component in a range of about 18 KHz to about 20 KHz. In a further aspect, the at least one ultrasonic pulse may have a primary frequency component of about 19 KHz. In some non-limiting examples, the ultrasonic pulse may have a primary frequency component of about 15 KHz, about 16 KHz, about 17 KHz, about 18 KHz, about 19 KHz, about 20 KHz, about 21 KHz, about 22 KHz, about 23 KHz, about 24 KHz, about 25 KHz, about 26 KHz, or any value or range of values therebetween including endpoints. In one non-limiting example, using a narrow-bandwidth 19 KHz acoustic pulse or beep may allow for aggressive digital filtering to attenuate background noise. Furthermore, a narrow-bandwidth 19 KHz acoustic pulse or beep may improve localization sensitivity over a range of frequencies since a wider bandwidth may contain more noise in a pass band directed to such a range of frequencies. Additionally, using a narrow-bandwidth 19 KHz acoustic pulse or beep may allow for transmission at a lower acoustic volume. In some non-limiting aspects, a narrow signal band may be defined as having a bandwidth of less than or equal to about 10% of the center frequency of the signal band.

In one aspect, a data stream composed of or defining characteristics of the ultrasonic pulses may be transmitted from the mobile device 1803 via a wireless channel to the acoustic transmitters 1805 via an audio circuit 1807. Such characteristics may include, without limitation, a transmission frequency, and/or a transmission amplitude including a transmission amplitude envelope. The data stream may be transmitted via an antenna 1811 of the mobile device 1803. The antenna 1811 may be a component of the primary communication scheme of the mobile device 1803 or a component of a secondary communication scheme of the mobile device 1803, such as Bluetooth.

The audio circuit 1807 may be configured to provide operating signals to the acoustic transmitters 1805 and may include one or more transmitter amplifiers and logic circuits designed to synthesize data that may be used as an input to the one or more transmitter amplifiers. The audio circuit 1807 may further include components to receive the data stream transmitted from the mobile device 1803 over the wireless channel. The audio circuit 1807 may also convert the information from the data stream into one or more signals that may be sourced to the one or more transmitter amplifiers for transmission by the acoustic transmitters 1805. The acoustic transmitters 1805 and audio circuit 1807 may be implemented as part of the audio system of a vehicle having a multi-channel surround sound system. In such an example that uses the vehicle audio system, additional dedicated speakers beyond those already disposed within the vehicle may not be required.

The system 1800 may also include a control module 1801 that may be configured to inhibit at least one function of the mobile device 1803. The processor 1813 may be in communication with the control module 1801 of the mobile device. As shown in the aspect of FIG. 1, the control module 1801 may be located within the mobile device 1803 or it may be communicatively coupled to the mobile device 1803 such that control and/or command signals can be exchanged between the control module 1801 and the mobile device 1803. Similarly, as shown in the aspect of FIG. 1, the processor 1813 may be located within the mobile device 1803 or it may be communicatively coupled to the mobile device 1803 such that information may be exchanged between the processor 1813 and the mobile device 1803.

Furthermore, in some aspects, control module 1801 may be associated with the mobile device 1803, in which the control module 1801 is coupled to a non-transitory memory that stores executable instructions, and the control module 1801 is operable to execute the instructions stored in the memory. The control module 1801 may be operable to receive a command signal from a processor 1813 and inhibit at least one function of the mobile device 1803 upon reception of the command signal. As shown in FIG. 1, in one aspect, the control module 1801 may be located within the mobile device 1803. In another aspect, the control module 1801 may be in communication with the mobile device through a communication network, such as a wireless communication network. The control module 1801 may also be configured to inhibit the at least one function of the mobile device 1803 upon the processor 1813 determining that the location of the mobile device 1803 matches the predetermined detection zone. The control module 1801 may also be configured to redirect at least one function of the mobile device 1803 to a hands-free alternate system upon the processor 1813 determining that the location of the mobile device 1803 matches the predetermined detection zone.

During aspects of mobile device detection, each speaker 1805 may be configured to emit a ranging acoustic signal that comprises short pulse of a high frequency sound signal. The mobile device 1803 may be configured to capture the ranging acoustic signal via an acoustic receiver 1809, such as a microphone of the mobile device 1803. The processor 1813 may be configured to calculate a time-of-flight of the ranging acoustic signal and determine a location of the mobile device 1803 in reference to a predetermined detection zone based on the time-of-flight.

Once a determination is made by the processor 1813 as to whether the mobile device 1803 is within the predetermined detection zone, the processor 1813 may cause a signal to be sent to the mobile device 1803 for inhibiting a function of the mobile device 1803. In some examples, in which the processor 1813 is independent of the mobile device 1803, the signal may be received via an antenna 1811 of the mobile device 1803. Once an appropriate signal is received by the mobile device 1803, operation of the mobile device 1803 may be controlled in one or more ways. For example, in one aspect, the mobile device 1803 may be associated with control module 1801 that disables or inhibits the operation of at least one function of the mobile device 1803. Thus the mobile device 1803 is rendered either inoperable or operable only in a state of limited capacity. Accordingly, the control module 1801 may be able to either completely block the ability to receive or send a call on a mobile device 1803, or sufficiently interfere with a function of the mobile device 1803 so as to make the mobile device 1803 usage undesirable. In aspects, the control module 1801 may disable the operation of certain components or functions of the mobile device. For example, a keyboard portion of a mobile device 1801 may be disabled to prevent the user from using a text messaging function or an email function of the mobile device. In another aspect, the control module 1801 may direct the operation of the mobile device 1803 to a hands-free operation. In another aspect, outgoing communication functions may be inhibited, but incoming communication functions may not be inhibited. In another aspect, automatic replies may be initiated during a period in which a function of the mobile device 1803 is inhibited.

In aspects, the processor 1813 may be coupled to a non-transitory memory that stores executable instructions, and the processor 1813 may be operable to execute the instructions. The processor 1813 may be operable to execute the instructions to receive the an electrical signals from an acoustic receiver 1809 of the mobile device 1803, in which each electrical signal is based on each of the one or more ranging acoustic signals received by the acoustic receivers 1809. The processor 1813 may be configured to determine a location of the mobile device 1803 based on the time of reception of the ranging acoustic signals by the acoustic receiver 1809, and to determine whether the location of the mobile device 1803 matches the predetermined detection zone.

In one aspect, the processor 1813 may be operable to determine the location of the mobile device 1803 based on a distance from the mobile device 1803 to each of the plurality of acoustic transmitters 1805. Further, the processor 1813 may be operable to determine the distance of the mobile device 1803 from each of the plurality of acoustic transmitters 1805 based on a time difference in transmission from each of the plurality of acoustic transmitters 1805 of the ranging acoustic signals. In one aspect, the processor 1813 may be a mobile application processor. Further, in one aspect, the processor 1813 may be located within the mobile device. In another aspect, the processor 1813 may be independent of the mobile device 1803 and communicatively coupled to the mobile device 1803. Further, in some aspects, components or functions of the processor 1813 may be part of or performed by the mobile device 1803. Accordingly, the mobile device may receive a communication signal from the processor 1813 that provides information regarding a time of reception of each ranging acoustic signal at the acoustic receivers 1809 of the mobile device 1803

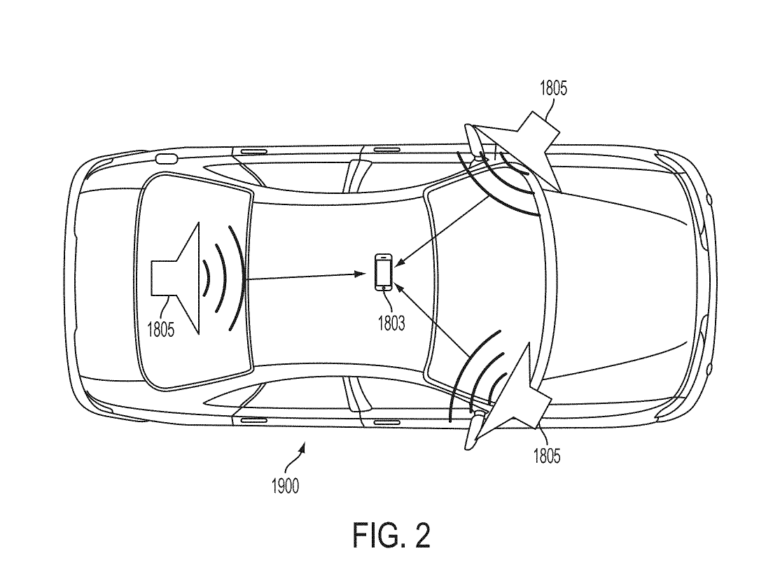

The plurality of transmitters 1805 may be a plurality of acoustic transmitters, such as speakers, located inside of a cabin of a vehicle. One aspect of a location of the speakers 1805 is shown in FIG. 2. The speakers 1805 may be dedicated and integrated with the vehicle when the vehicle is manufactured, or the speakers may be added to the vehicle. In one aspect, the speakers 1805 may be dedicated speakers that optimized for high frequency sounds transmission. In one aspect, the speakers 1805 may be a specific type of loudspeaker (usually dome or horn-type) designed to produce high audio frequencies, such as a Tweeter.

Further, the system 1800 may employ two or more speakers 1805. In one aspect, three or more speakers may be implemented to provide ultrasonic pulses or pings. As depicted in FIG. 2, the speakers 1805 may include three speakers 1805 in which two of the speakers 1805 may be located in areas proximate to the driver's seat and the front passenger side seat, respectively. An additional speaker 1805 may be located at the rear of the vehicle cabin. In one non-limiting example, a third speaker 1805 may be located in the rear of the vehicle cabin at a position at about the middle of the rear vehicle cabin. It may be recognized that although three speakers 1805 are depicted in FIG. 2, additional speakers 1805 may be included. Thus, for example, four speakers 1805 may be located within the vehicle, in which two of the speakers 1805 are located in areas proximate to the driver's seat and the front passenger seat, respectively, and two additional speakers 1805 are located in areas proximate to and behind the rear driver side seat and the rear passenger side seat, respectively. It may be recognized that the 3 or more speakers may be located arbitrarily throughout the vehicle without limitation.

Although the present disclosure may include examples specific to a sedan-type passenger vehicle, the methods and systems disclosed herein may also be used in other types of vehicles. Such vehicles may include, without limitation, trucks (such as pickup trucks, panel trucks, and 18-wheel trucks), vans, busses, and other multi-passenger vehicles. As an example, a multi-passenger vehicle may include a bus in which a plurality of speakers are disposed in opposing pairs beside one or more rows of passenger seats.

In addition, a method for determining a presence of a mobile device located in a predetermined detection zone may include transmitting a sequence of acoustic pulses through the multiple acoustic transmitters, for example a plurality of speakers 1805. A first pulse may be transmitted at about 19 KHz and may be separated in time from a second pulse transmitted at about 19 KHz by a pre-defined time delay. The sound received at the acoustic receiver of the mobile device 1803 may be recorded. The ranging acoustic signal from each speaker 1805 may be identified and the time difference between each pulse may be analyzed. Based on the time difference between the pulses, a relative distance may be calculated to each speaker and a determination is made as to whether the mobile device is in the driver zone or not.

Additional description of aspects of mobile device detection is provided. In some aspects, the ranging acoustic signal received by the acoustic receiver of the mobile device may be converted to an electrical signal and the electrical signal may include information regarding the acoustic parameters of the ranging acoustic signal. In some non-limiting examples, the information associated with the ranging acoustic signal may include a frequency, an amplitude, a phase, and data encoded in the ranging acoustic signal. Such encoded data may include, without limitation, a transmitter identifier, a signal modulation type (amplitude, frequency or phase), an identifier of signal duration, and an identifier of a silent period between the transmission of a first ranging acoustic signal and a second ranging acoustic signal. In some aspects, the mobile device may be configured to extract the information from the electrical signal. The information extracted from the electrical signal may be used by the mobile device as part of one or more methods to analyze the electrical signal to determine a location of the mobile device within the vehicle.

In some aspects, processing is performed on the electrical signal to determine a location of the mobile device within a vehicle. In some aspects, the systems and methods of the present disclosure may include a sound player, a sound recorder, and/or a sound filter that perform particular functions of the necessary signal processing. In some non-limiting examples, sound players may be MP3 players or Wave players. In some non-limiting examples, the sound recorder may be configured to receive signal outputs from one or more microphones. In some aspects, the audio signal received by a microphone element may be filtered by a simple analog low pass filter to remove components above twice the S/D sampling frequency. The analog filtered signal may then be converted to a digital signal by means of an analog-to-digital converter. In some non-limiting examples, additional filtering of the digital signal may be employed. Additional digital filters may include, without limitation, any one or more filtering algorithms that may include FIR filters, IIR filters, FFT transforms, and inverse FFT transforms. Furthermore, the signal processing components and functions described may be implemented by a processor device located within the mobile device or by a processor device in communication with the mobile device.

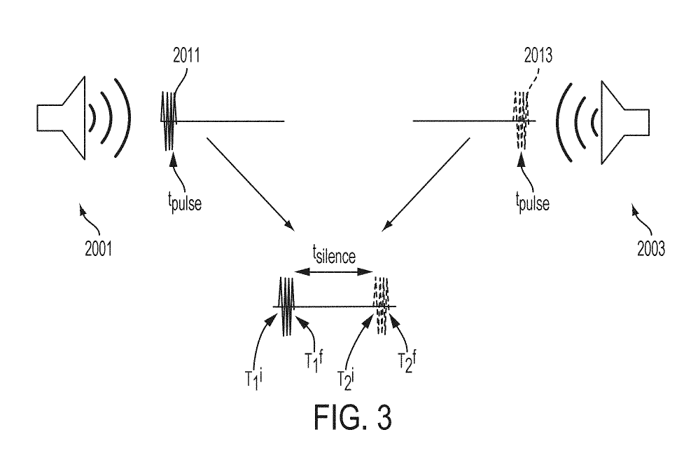

As an example of a method for calculating a location of a mobile device based on the receipt of ranging acoustic signals, a relative location of a mobile device can be calculated using the speed of sound. The following description may be considered in view of FIG. 3. In the example of FIG. 3, two speakers are shown, a left speaker 2001 and a right speaker 2003. The left speaker 2001 may emit a first pulse 2011 at time t₀=0. In some aspects, the first pulse may have a duration of about tₚᵤₗₛₑ. The right speaker 2003 may emit a second pulse 2013 at time t₁ about equal to t₀+tₚᵤₗₛₑ+t_{silence}. In some non-limiting examples, the second pulse 2013 may also have a duration of about tₚᵤₗₛₑ. It may be recognized that the duration of the first pulse 2011 and the duration of the second pulse 2013 may be the same or may differ. In one example, t₁ may be about 200 ms if tₚᵤₗₛₑ is about 10 ms and t_{silence} is about 190 ms.

The mid-point 2015 between the two speakers 2001, 2003 may be a distance of about m from each speaker. In one example, one may suppose that the mobile device is calculated to be a distance of about d right of the midpoint 2015 between left speaker 2001 and right speaker 2003. In American vehicles, this would be a position proximate to the front passenger side seat. However, it may be understood that in some non-American vehicles, for example vehicles designed for operation in Great Brittan, Australia, and New Zealand, this calculated position may correspond to a position proximate to the front driver's side seat. In general, the systems and methods disclosed herein are equally applicable for the use of vehicles driven in right-hand traffic territories as well as in left-hand traffic territories with the appropriate changes in the sense of the locations of the mobile devices. Therefore, the distance of the mobile device from the right speaker 2003 is (m−d), and the distance of the mobile device from the left speaker 2001 is (m+d). Let the speed of sound be v.

For purpose of the following example only, each of the first pulse 2011 and the second pulse 2013 may be characterized by an audio frequency bounded by an amplitude envelope that is approximately rectangular. The first pulse 2011 from the left speaker 2001 may be detected at the rising edge of the rectangular envelope at a time T₁ⁱ (time of initial detection of the first pulse 2011):

T₁ⁱ=0+(m+d)/v

The first pulse 2011 will be detected until a time T₁^{f} (time of final detection of the first pulse 2011, at the falling edge of the rectangular amplitude envelope):

T₁^{f}=tₚᵤₗₛₑ±(m+d)/v

For the present example, tₚᵤₗₛₑ for the first pulse 2011 may be about 10 ms, and therefore T₁^{f} may result in

T₁^{f}=10+(m+d)/v

The second pulse 2013 from the right speaker 2001 may be detected at the rising edge of the rectangular envelope at a time T₂ⁱ (time of initial detection of the second pulse 2013):

T₂ⁱ=0+tₚᵤₗₛₑ+t_{silence}+(m−d)/v

Using the values of tₚᵤₗₛₑ=10 ms and t_{silence}=190 ms, as disclosed in the example above,

T₂ⁱ=0+10+190+(m−d)/v=200+(m−d)/v

The second pulse 2013 will be detected until a time T₂^{f} (time of final detection of the first pulse 2011 at the falling edge of the rectangular envelope):

T₂^{f}=0+tₚᵤₗₛₑ+t_{silence}+tₚᵤₗₛₑ+(m−d)/v=210+(m−d)/v

The silence between the two pulses, specifically, from the falling edge of the first pulse 2011 to the rising edge of the second pulse 2013 is measured:

T_{silence}=T₂ⁱ−T₁^{f}=200+(m−d)/v−(10+(m+d)/v)

T_{silence}=190−2d/V

which, on rearrangement, becomes

0.5*(190−T_{silence})*v⁼d

Therefore, the relative distance d from the center point can be calculated by finding the small shift in the silence period between the two pulses. Using the equations above, for an average speed of sound in air of about 34.3 cm/msec, if the measured period of silence T_{silence} between the received pulses is 189.207 msec., then the relative distance of the mobile device from the mid-point 2015 may be about

d=0.5*34.3 cm/msec·(190 ms−T_{silence})

d=17.15 cm/msec·(190 ms−T_{silence})=13.6 cm

In the above example, the relative placement is 13.6 cm, or 13.6 cm to the right of the midpoint 2015 between the two speakers 2001, 2003.

Additionally, a method for determining a presence of a mobile device located in a predetermined detection zone may include the following steps: transmitting ranging acoustic signals, by each of a plurality of transmitters, to the mobile device; receiving, by the mobile device, each ranging acoustic signal transmitted by the plurality of transmitters; determining, by a processor, a location of the mobile device based on the communication signals transmitted by the plurality of transmitters and received by the mobile device; determining whether the location of the mobile device matches the predetermined detection zone; and inhibiting at least one function of the mobile device upon determining that the location of the mobile device matches the predetermined detection zone. In some non-limiting examples, each of the ranging acoustic signals may be composed of at least one ultrasonic pulse at 19 kHz. However, as disclosed above, the ranging acoustic signal may be composed of one ultrasonic pulse having a primary frequency component of about 15 KHz, about 16 KHz, about 17 KHz, about 18 KHz, about 19 KHz, about 20 KHz, about 21 KHz, about 22 KHz, about 23 KHz, about 24 KHz, about 25 KHz, about 26 KHz, or any value or range of values therebetween including endpoints. In some aspects, the predetermined detection zone may include a three dimensional area surrounding or proximate to the driver's seat in the vehicle.

In some aspects, determining the location of a mobile device may comprise determining the location of the mobile device based on a distance from the mobile device to each of the plurality of receivers. In one aspect, the distance of the mobile device to each of the plurality of receivers may be determined based on a time difference in reception at each of the plurality of receivers of a ranging acoustic signal transmitted by the mobile device. In an alternative aspect, the distance of the mobile device to each of the plurality of receivers may be determined based on a time difference in reception by the mobile device each of a plurality of ranging acoustic signals transmitted by a plurality of transmitters.

In some additional aspects, determining the location of the mobile device may include determining the location of the mobile device based on a triangulation method. It may be understood that the resolution of location determination of the mobile device depends on the number and spacing of the transmitters. Thus, a single transmitter may only allow the location of the mobile device to be determined in a single dimension, that is, a linear distance of the mobile device from the single transmitter. Two transmitters may allow the location of the mobile device to be determined in two dimensions. In a non-limiting example, if the two transmitters are disposed on opposing sides of the vehicle dashboard, the system may determine the location of a mobile device along a left-right axis within the vehicle cabin. Three or more transmitters may be used to determine the location of the mobile device in three dimensions. As one non-limiting example, if two speakers are disposed on opposing sides of the vehicle dashboard and a third speaker is disposed midway along a rear portion of the vehicle cabin, the system may determine the location of a mobile device along a lift-right axis as well as a front-rear axis within the vehicle cabin. Although only three transmitters may be necessary to determine the location of the mobile device in three dimensions, it is well recognized that the use of four or more transmitters can be used to reduce the error in the calculation of the location in three dimensions.

In addition, a ranging acoustic signal transmitted by any one or more of a plurality of acoustic transmitters may include additional information encoded in the signal. Such additional information may include location information or identification information that allows each of the acoustic transmitters to be identified based on information contained in the ranging acoustic signal. In one non-limiting example, each transmitter may be assigned an identification number, and the identification number may be encoded in the ranging acoustic signal transmitted by the transmitter. Such identification information may be helpful in identifying a ranging acoustic signal since acoustic noise would not include such an encoded identification number.

It may be recognized that the use of ranging acoustic signal detection for the localization of a mobile device in a vehicle may suffer from a variety of effects that may reduce the effectiveness of the technique. For example, the ranging acoustic signal frequency should be outside the normal range of hearing for humans. Typically for adult humans, the high frequency end for normal hearing may be around 17 kHz, although children may be able to hear higher frequencies. Thus, the main frequency of the ranging acoustic signals should be outside the range of human hearing so as not to distract the driver and/or passengers. Ranging acoustic signals within a vehicle may also suffer from multi-path distortions due to the location of sound deflecting elements within the vehicle capable of scattering and reflecting sound within the vehicle cabin. Such sound deflecting elements may include, without limitation, the human occupants, the vehicle seats, and other items such as packages carried by or along with the occupants. Fading and amplitude attenuation may also interfere with the proper receipt of ranging acoustic signals. Fading and amplitude attenuation may be due to many different effects and/or combination of effects including, without limitation, the placement of the mobile device about an owner, the disposition of the vehicle occupants, including their packages and clothing within the cabin, and the vehicle seating material. Additionally, acoustic noise may interfere with the signals. Non-limiting examples of such acoustic noise may be due to music, human speech, animal noises (if a dog or cat is in the vehicle), road noises, and engine noises. Disclosed below are techniques that may be used to overcome such effects.

Acoustic localization needs to be silent to human. Table 1 identifies the following types of audible perception of ranging acoustic signal and proposed the following solution.

TABLE 1

| Perceived Sound | Root Cause | Solution |
|---|---|---|
| High frequency | Perception of high | Limit the lowest frequency |
| ringing or | frequency sound | of the acoustic ping. |
| mosquito song | | At minimum: |
| | | Greater than 17 KHz. |
| | | Young adult and children |
| | | might still be able to hear |
| | | at high volume. |
| | | Better: |
| | | Greater than 19 KHz. |
| | | Majority of the population |
| | | cannot hear above 19 KHz. |
| Sense of vibration | Rapid increase or | Reduce the speed of |
| | decrease in volume cause | increasing or decreasing |
| | a feeling of vibration | volume. |
| | | For example, set ramp up |
| | | or ramp down time to be at |
| | | least 1 milliseconds. |
| Crackling sound | Distortion of speaker and | Use a lower volume |
| | amplifier at high volume | |
| Click sound | Distortion of speaker due | Reduce the speed of |
| | to rapid increase or | increasing or decreasing |
| | decrease in volume | volume. |

In one aspect, a ranging technique may be used to calculate the position of the mobile device based on the ranging acoustic signal transmitted by a vehicle's speaker system. In order to reduce the unwanted perception of the acoustic ping, it is necessary to minimize the amplitude of the ping. However, lower volume or energy also reduces the accuracy of the location calculation due to degradation due to a decrease in the overall signal to noise ratio. One technique is to apply pulse compression technique to the acoustic ping. The pulse compression spreads a lower transmission volume over a wider frequency range. This may result in a less perceived volume and an increase signal to noise ratio after the application of a matched filter.

In one aspect, information is encoded using pulse compression by modulating the transmitted ranging acoustic signal and then correlating the received signal with the transmitted ranging acoustic signal. In one example, signal compression may be accomplished by frequency modulation in a linear or non-linear manner from a lower frequency to a higher frequency. A receiver may include a filter matched to the frequency modulation characteristics of the transmitted signal. The receiver may thus be said to “decompress” the signal. The modulated ranging acoustic signal may be transmitted according to certain parameters such that signal processing is accomplished using the same or similar processes as described above, for example using frequency spread or amplitude modulation of the pulse compression signal or similar methods.

Additional aspects might be required to further improve the pulse compression technique. These techniques may include additional amplitude modulation or windowing, determination of phase differences between low and high frequencies of the ping, or determination of phase characteristics of a set of fixed frequencies.

As disclosed above, reflection and scattering of ranging acoustic signals may interfere with the ability of a mobile device to use them for localization purposes. For example, if a signal is generated in a highly reflective multi-path environment, multiple copies of the signal pulse may be scattered in time across the coherence time of the environment. In a vehicle cabin, the sound waves often reflect and scatter. Reflection and scattering can cause impairment to the signal such as multi-path effect and frequency selected fading. Several techniques may be employed to address multi-path effect. One non-limiting example of such a technique may include: selecting the first peak that represents the shortest path between the speaker and microphone; and applying a equalization process where the multi-path characteristic is first measured and then its effect reversed. In another non-limiting example, the technique may include selecting the signal having the greatest amplitude.

As disclosed above, aspects that may interfere with the use of a ranging acoustic signal to detect the presence of a mobile device may include signal drop-out, fade, or attenuation. In some examples, a ranging acoustic signal may be not properly received by a mobile device because the user may accidentally occlude the microphone. In one example, that user may hold a mobile device so that one of the user's finger may cover the microphone thereby reduce the sensitivity of the microphone. Once the microphone is covered, the ranging acoustic signal be not be properly received thereby reducing the ability of the mobile device to determine its location.

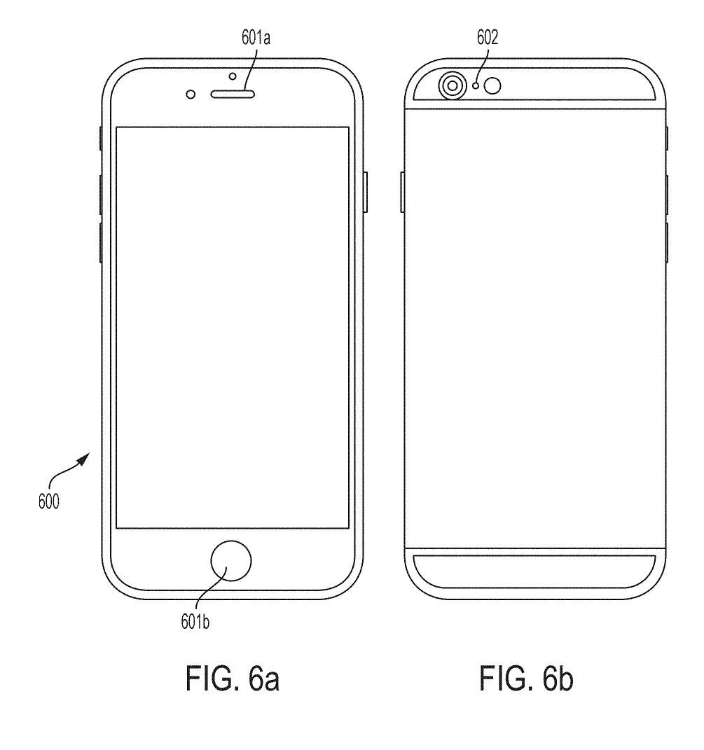

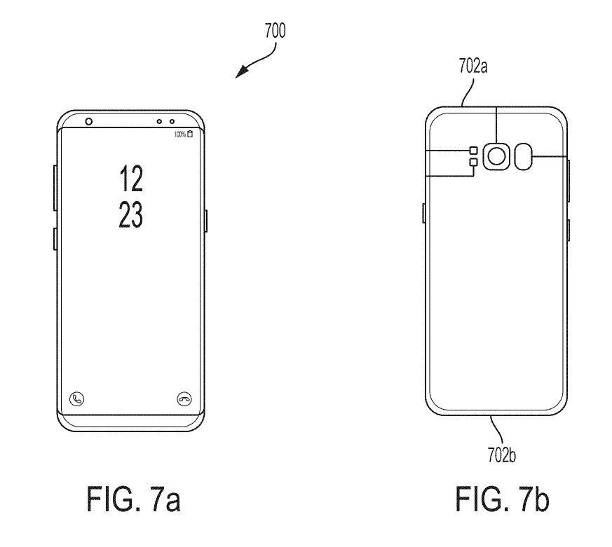

On most smart devices, there may be multiple microphones. FIGS. 6A,B and FIGS. 7A,B depict exemplary mobile devices that may have multiple microphones. FIGS. 6A,B depict the front side and the rear side, respectively, a one aspect of a mobile device 600. In FIG. 6A, two front microphones 601a,b are depicted. Specifically, a first front microphone 601a may be disposed on or proximate to the upper edge of the mobile device 600 and the second front microphone 601b, may be disposed on or proximate to the lower edge of the mobile device 600. In FIG. 6B, a single rear microphone 602 is depicted. Specifically, the rear microphone 602 may be disposed on or proximate to the upper edge of the mobile device 600. FIGS. 7A,B depict the front side and the rear side, respectively, a one aspect of a mobile device 700. No microphone inputs are visible in FIG. 7A. In FIG. 7B, two rear microphones 702a,b are depicted. Specifically, a first rear microphone 702a may be disposed on or proximate to the upper edge of the mobile device 700 and the second rear microphone 702b, may be disposed on or proximate to the lower edge of the mobile device 700.

For a mobile device having multiple microphones, an algorithm within the mobile device may be used to determine that one of the multiple microphones is not occluded and then record one or more ranging acoustic signals using the output of the un-occluded microphone. An aspect of a software algorithm that automatically detects covered microphone port and then choose another microphone may include: receiving a known ranging acoustic signal by a mobile device; recording the ranging acoustic signal using all available microphones of the mobile device; analyzing the recording from each available microphones; and determining which microphone has the greatest average signal amplitude for the known ranging acoustic signal.

It may be recognized that acoustic attenuation due to microphone occlusion may affect all or most of the frequencies that compose a ranging acoustic signal. However, in some aspects, signal attenuation may be frequency dependent. Several methods may be used to address frequency selective fading. In some examples, a larger bandwidth of frequencies may be used to form the ranging acoustic signal. Such a method may reduce the effect of frequency selective fading because not all of the band may be affected. In an alternative method, time dependent frequency switching may be used so that a frequency component affected by the frequency dependent fading would not be used in at least some of the ranging acoustic signals. This technique is similar to spread spectrum or frequency hopping methods.

Acoustic attenuation may also be position-dependent. In the specific application of detecting the driver seat, the acoustically-determined location needs to be optimized for the driver seat. Because of the obstruction such as instrument dashboard, steering wheel, and the long propagation path, the signal from the right speaker (or passenger side speaker) may be weakened near the driver. The weak ranging acoustic signal from the passenger speaker may lead to failure in localization. One technique to improve the location accuracy is to boost the amplitude of the ranging acoustic signal from the passenger side.

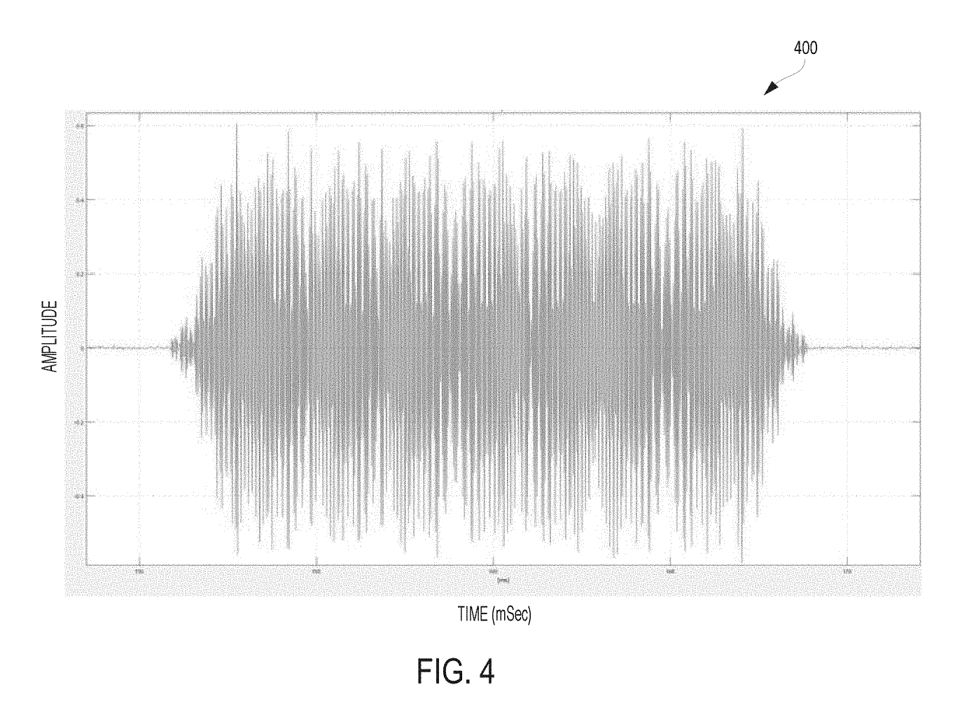

Acoustic noise may also interfere with the ability of a mobile device to determine its position based on the receipt of one or more ranging acoustic signals. In one aspect, ranging acoustic signals may be correctly identified by the mobile device despite background acoustic noise based on the transmission of ranging acoustic signals having predetermined characteristics or a known sequence of sounds. If the transmitted ranging acoustic signals are defined according to predetermined characteristics, the mobile device may be able to filter out many extraneous acoustic signals (such as human speech, engine noise, or road noise) that do not have such characteristics. Without limitation, the known sequence or predetermined characteristics of the ranging acoustic signals may be generated using any one or more of the following techniques: frequency modulation (where the frequency of the transmitted signal varies), amplitude modulation (where amplitude of the transmitted signal varies), and phase modulation (where the phase or delay of the transmitted signal changes). In some aspects, non-limiting examples of frequency modulation may include: a linear chirp (in which frequency increase or decrease linearly over time), a non-linear chirp (in which frequency increase or decrease non-linearly over time), or any combination or combinations thereof. FIG. 4 depicts an example of a raw audio signal 400 recorded by a microphone of a mobile device. The sound signal may include components including the ranging acoustic signal, engine noise, road noise, human conversation, and other audio components.

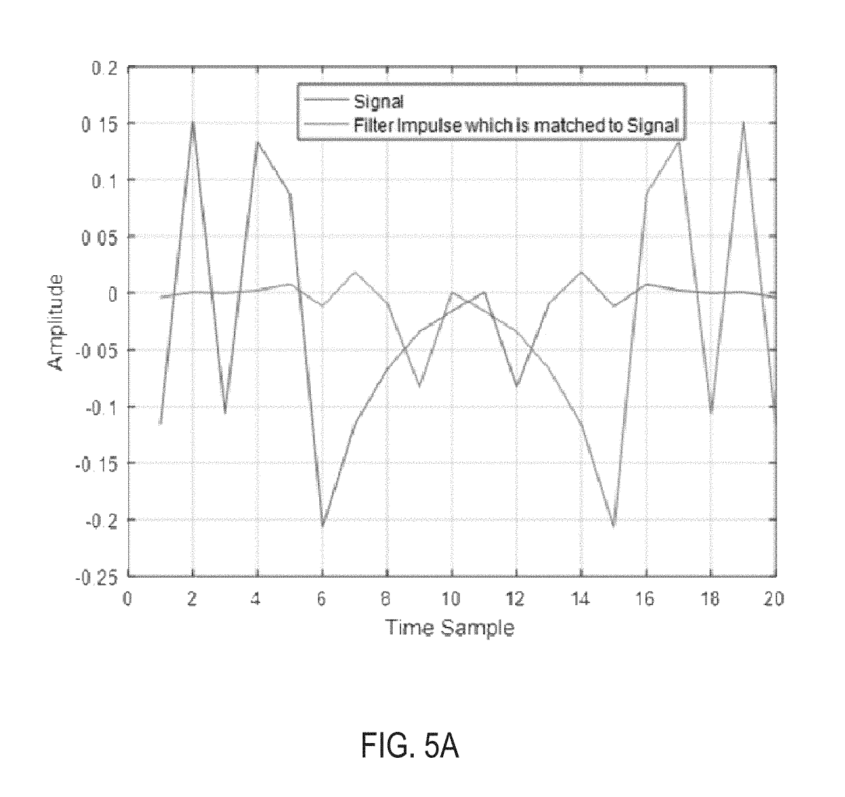

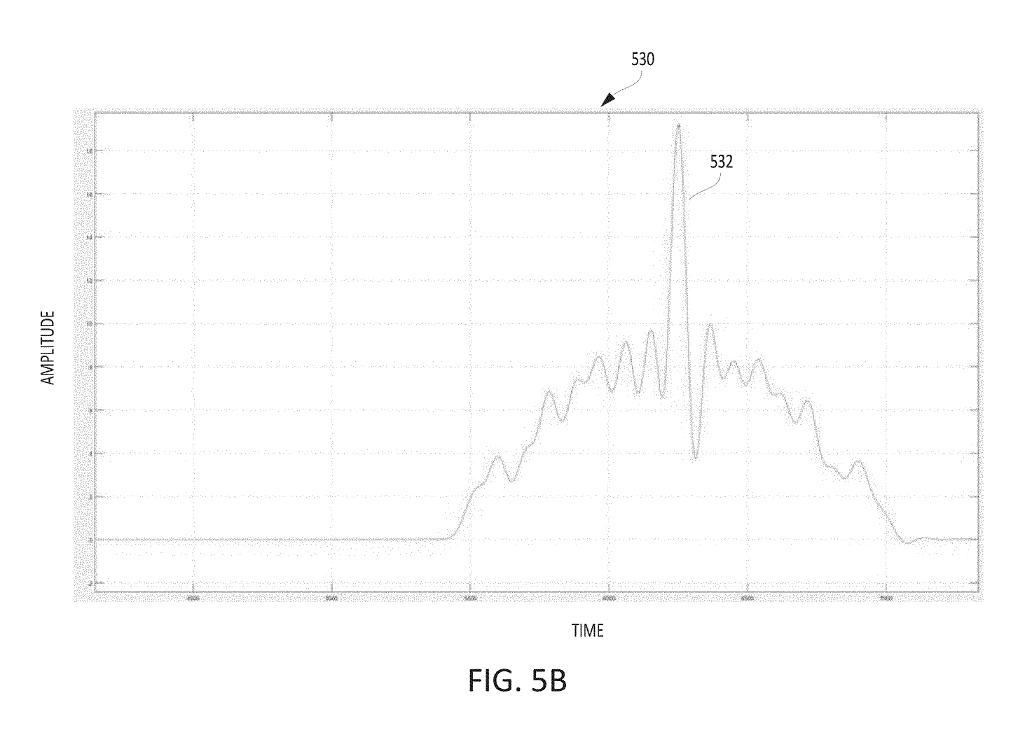

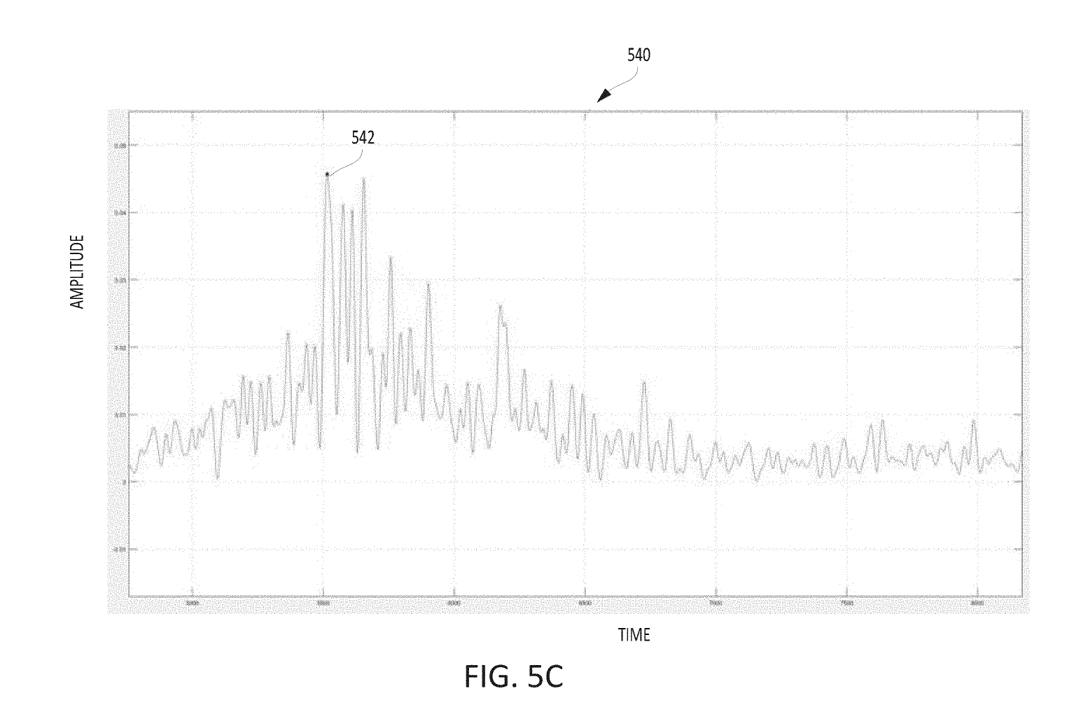

The mobile device may be configured to use one or more mathematical methods that may be configured to detect a signal having predetermined signal characteristics. Non-limiting examples of these methods may include the use of matched filters or an auto-correlation operation. FIG. 5A plots the initial time course of the ranging acoustic signal 510 along with the initial time course of a filter 520 matched to that signal. In some aspects, a matching filter may be constructed as a conjugated time-reversed version of the signal to which it is matched. The ranging acoustic signal 510 may be extracted from the audio signal recorded by the mobile device 400 by correlating the audio signal 400 and the matching filter 520. The matching filter 520 may be the optimal linear filter to maximize the signal-to-noise ratio in the presence of stochastic noise. Matched filtering is a demodulation technique with linear time invariant filters. In some alternative aspects, matched signal filtering may be implemented using, without limitation, any one or more of a finite impulse response (FIR) filter, an infinite impulse response (IIR) filter, a Fast Fourier Transform (FTT), and an Inverse Fast Fourier transform (inverse FFT).

FIG. 5B particularly displays in the time domain, the result of a recorded audio signal 400 after being filtered through the matching filter 520, in which the acoustic ranging signal is at least partially recovered 530. In this example, the audio recorded signal 400 does not include reflections or distortions due to multipath transmission within the vehicle. It may be observed in FIG. 5B that the recovered signal 530 is composed of a single major amplitude peak 532. It may be recognized that the recovered signal 530 in FIG. 5B shows only a single peak which may represent a signal received by the mobile device directly from the source(s) of the ranging acoustic signal.

It may be recognized that the confined environment of a vehicle may cause multiple reflections of the raging acoustic signal before it is recorded by the mobile device. FIG. 5C depicts in the time domain the result of a recorded audio signal 400 after being filtered through the matching filter 520, in which the recorded audio signal includes multipath distortions to the original ranging acoustic signal 540. Unlike the recovered signal 530 depicted in FIG. 5B, the recovered signal 540 in FIG. 5C includes multiple distinct peaks. Each peak in the recovered signal 540 may represent a separate reflected signal derived from the originally transmitted ranging acoustic signal. In some instances, the largest peak 542 may not correspond to an acoustic ranging signal directly received by the mobile device without reflections. In such cases, additional signal processing may be required to determine the peak corresponding to the directly transmitted ranging acoustic signal.

Additional signal processing of the recorded signal. For example, the recorded audio signal 400 depicted in FIG. 4 may be band filtered to remove frequency components outside of a desired range of frequencies (for example, a band filter centered at about 19 KHz with cut-off values at about 18 KHz, and 20 KHz). A noise floor filter may then be applied to the band-limited signal to remove some noise components within the band. The resulting signal may be transformed according to an FFT filter to determine the frequency components of the resulting signal. In some additional examples, filters specifically designed to detect signals having the known frequency and amplitude characteristics of the acoustic ranging signals may be applied.

It is recognized that the filtering operations as well as additional techniques may rely on digital signal processing. The effectiveness of the digital signal processing may be dependent of the accuracy of the digital sampling of the audio signal. The sample rate of an audio signal may be dependent on the sampling capabilities of the mobile device. In some examples, the operation system for a smart device such as an iOS device or an Android device may support multiple sample rates, such as 8 KHz, 22.05 KHz, 32 KHz, 44.1 KHz, 48 KHz, 64 KHz, 96 KHz and greater. One aspect of a acoustic-based localization algorithm requires a sample rate of at least 40 KHz, the Nyquist limit for a signal occupying 20 KHz of bandwidth. Additional sampling rates may include, for example and without limitation, 44.1 KHz, 48 KHz, and 96 KHz. A sample rate of lower than 40 KHz cannot resolve the high frequency content of the acoustic ping above half the Nyquist rate (or 20 KHz). It is generally recognized that a digital sampling frequency F must be at least twice that of the highest frequency being sampled to prevent frequency aliasing according to the Nyquist criterion. Thus, a 40 KHz sampling frequency can properly resolve ranging acoustic signals having frequency components at or below 20 KHz. However, an acoustic ranging signal having components greater than 20 KHz will be susceptible to aliasing, resulting in errors in the frequency analysis of the ranging acoustic signal. Consequently, the use of sampling frequencies above 40 KHz may be desirable for sampling acoustic ranging signals having higher frequency components, such as those resulting from frequency modulation.

In some aspects, acoustic interference may be due to high volume interference. In some aspects, the shear volume of interfering acoustic noise, such as high music volume or road noise, may overwhelm the ranging acoustic signal, thereby affecting the accuracy of the location detection. One technique to address this matter may be a software algorithm configured to detect presence of high acoustic volume, and then adjust the volume of the ranging acoustic signals accordingly to increase signal level.

In some aspects, techniques may be used to optimize the detection of a mobile device in a specific predetermined detection zone within the vehicle. Such techniques may differ from those used to determine the location of a mobile device regardless of its location in a vehicle. For example, there may be a need to focus on the location of a mobile device in which the predetermined detection zone is in or near a passenger seat. In such a case, it may be possible to boost the range of a ranging acoustic signal issued from or near the driver's seat thereby improving the accuracy of detection at the passenger side. Table 2 describes several methods to boost the signal, depends on the goal of optimization.

TABLE 2

| | Driver side speaker | |
|---|---|---|
| Goal | signal | Passenger side signal |
| Optimize for driver | | 1. Increase signal |
| localization accuracy | | strength OR |
| | | 2. Use frequency that's |
| | | less prone to fading. OR |
| | | 3. Use frequency that |
| | | smart phone has higher |
| | | sensitivity. OR |
| | | 4. Use a longer |
| | | transmission sequence |
| | | OR. |
| Optimize for passenger | 1. Increase signal | |
| localization accuracy | strength OR | |
| | 2. Use frequency that's | |
| | less prone to fading. | |
| | OR | |
| | 3. Use frequency that | |
| | smart phone has higher | |
| | sensitivity. OR | |
| | 4. Use a longer | |
| | transmission sequence | |
| | OR. | |

If the detection of a mobile device in a particular location is critical and requires high reliability, a software algorithm can set a default position for improved reliability. For example, if one must identify driver seat reliably, then software algorithm can assume the driver seat is the default location of the mobile device. Thus, unless the software algorithm has sufficient data to prove the mobile device is NOT located at or near the driver seat, then the algorithm will be default to a driver seat location. For another example, if one must reliably identify the location of a mobile device at a passenger seat, then software algorithm can assume the passenger seat is the default location. Unless the software algorithm has sufficient data to prove the mobile device is NOT located at or near the passenger seat, then the algorithm will be default to a passenger seat location.

As disclosed above, a plurality of audio transmitters disposed within a vehicle may emit one or more ranging acoustic signals that may be received by a mobile device. The mobile device, according to any of the techniques disclosed above, may thus calculate its physical location with respect to the plurality of audio transmitters. In some aspects, locations within the vehicle may be related to pre-determined detection zones. Thus, for example, physical locations associated with a three-dimensional volume at or proximate to the driver's seat may be considered a first pre-determined detection zone. However, other pre-determined detection zones may also be defined within a vehicle. In some aspects, a second pre-determined detection zone may be associated with a three-dimensional volume at or proximate to the front passenger's seat. In some aspects, a third pre-determined detection zone may be associated with a three-dimensional volume at or proximate to the passengers' seats behind the driver's seat and the front passenger's seat. In some alternative aspects, a third and a fourth pre-determined detection zone may be associated with a three-dimensional volume at or proximate to each of the passengers' seats behind the driver's seat and the front passenger's seat, respectively. It may be recognized further that, in general, a pre-determined detection zone may be associated with a three-dimensional volume at or proximate to each of the seats within a vehicle (such as in a multi-passenger vehicle such as a van).

Further, as disclosed above, a mobile device may be configured to restrict access to one or more applications loaded on the mobile device depending on the location of the mobile device within the vehicle. Thus, for example, a mobile device located within a pre-determined detection zone corresponding to a driver's seat may be configured to prevent the mobile device from sending or receiving text messages, sending or receiving phone messages (except for emergency calls), or accessing the internet via a browser application. Similarly, one or more of a text, phone, email, web browser, and navigation (map) application may also be restricted for a mobile device located in a zone corresponding to a front passenger seat. Alternatively, a mobile device located in a pre-determined detection zone corresponding to the front passenger seat may be enabled for any one or more text, phone, email, web browser, and navigation applications. For example, if the front passenger is acting as a “navigator,” it may be useful for a map application to be enabled for a mobile device located with the front passenger seat detection zone. Mobile devices located in a location zone corresponding to a rear passenger seat may be configured to permit use of a text application or a web browser application, but may be restricted in the use of video players and/or audio players. Such restrictions may be useful to prevent children in the rear passenger seat from using applications that may pose a distraction to a driver.

A mobile device may also include one or more SDK/API tools to receive the mobile device location information as determined according to the systems and methods disclosed above. Depending on the location of the mobile device, the SDK/API tools may restrict or permit access to additional applications loaded on the mobile device. Thus, while a mobile device located in a detection zone corresponding to a driver's seat may be shielded from receiving distracting content, a mobile device located at a detection zone corresponding to a passenger's seat may be enabled to receive content of interest. In one example, a mobile device located in a zone corresponding to a front passenger's seat may receive advertising information regarding a sale located at a store at an upcoming exit. In another example, a mobile device located in a zone corresponding to a rear passenger's seat may permit access to a video stream application associated with a monitor mounted for rear passenger viewing.

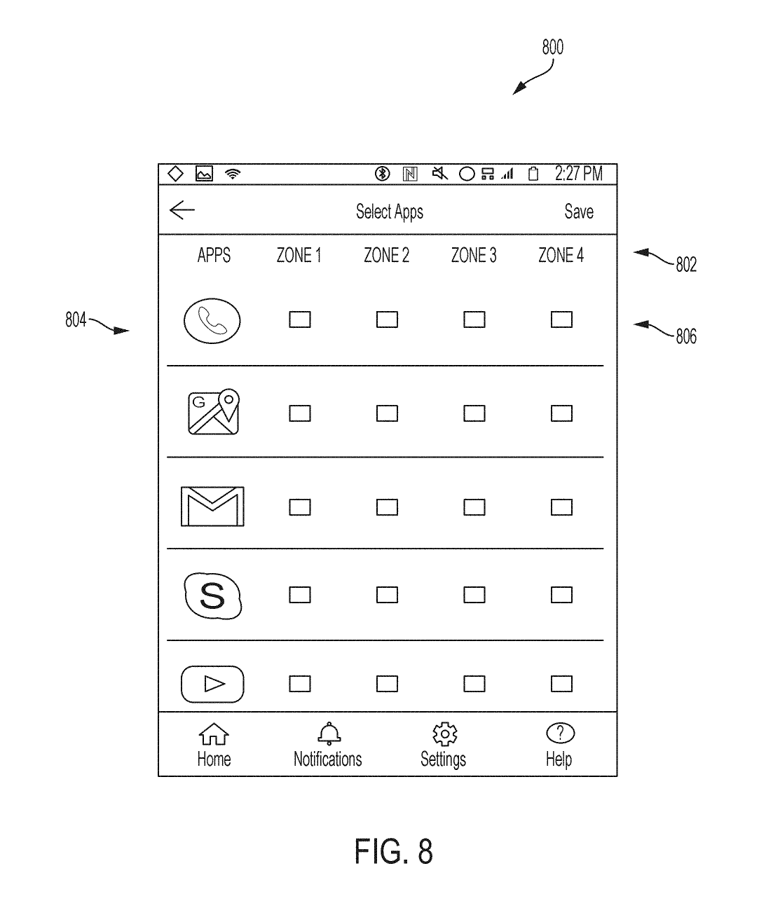

As disclosed above, a mobile device may be configured to permit or restrict access of a user to one or more applications depending on the location of the mobile device within a vehicle. The mobile device may be configured for such purpose by one or more individuals who may have appropriate programming privileges for the device (such as a parent, a work supervisor). FIG. 8 illustrates one example of a configuration graphical user interface 800 that may be used to configure the user access of a mobile device. The configuration graphical user interface 800 may include a list of indicia associated with mobile device application 804 and an indicator 806 associated with permission level for each of the detection zones 802 within a vehicle.

Examples of such application 804 on the mobile device may include, without limitation, a phone application, a mapping/navigation application, an email application, video conferencing application, and a streaming video display application. It should be understood that the applications need not include or be limited to any one or more of the applications displayed in graphical user interface 800. It may also be recognized that the graphical user interface 800 may have several display pages, sufficient to display all of the applications being configured for access. It may be further recognized that applications may be added or deleted from the configuration graphical user interface 800 as required.

The configuration graphical user interface 800 may also include a list of indicia associated with vehicle detection zones 802. These vehicle detection zones 802 may correspond to any of the pre-determined detection zones within the vehicle. As disclosed above, in one aspect, a zone 1 may correspond to a driver's seat, a zone 2 may correspond to a front passenger's seat, a zone 3 may correspond to a left rear passenger's seat, and a zone 4 may correspond to a right rear passenger's seat. It may be understood that the configuration graphical user interface 800 may be adapted to define more or fewer detection zones depending on the type of vehicle in which the mobile device is used.

In one non-limiting example, a user having privilege to set the access levels for each of the applications of a mobile device may configure a configuration graphical user interface 800 by touching one or more of the indicators 806 to permit or deny access to a specific application 804 when the mobile device is located in a specific detection zone 802. Alternatively, if the mobile device lacks a touch screen, the user having privilege to set the access levels may use a cursor and toggle device to select a particular indicator 806.

It may be recognized that the software that may implement any or any portion of the techniques and methods disclosed above may be resident in a non-transitory memory located within the mobile device, the vehicle, and/or vehicle add-on components. Such software may exit as one or more software packages or modules. Over time, the software may be upgraded or amended, and the upgraded software may be installed in the mobile device, the vehicle, and/or vehicle add-on components over WIFI, Cellular, 3G, 4G, Bluetooth communication links. The field upgradability of the software may allow improvement to the algorithm after it has been shipped.

While several forms have been illustrated and described, it is not the intention of the applicant to restrict or limit the scope of the appended claims to such detail. Numerous modifications, variations, changes, substitutions, combinations, and equivalents to those forms may be implemented and will occur to those skilled in the art without departing from the scope of the present disclosure. Moreover, the structure of each element associated with the described forms can be alternatively described as a means for providing the function performed by the element. Also, where materials are disclosed for certain components, other materials may be used. It is therefore to be understood that the foregoing description and the appended claims are intended to cover all such modifications, combinations, and variations as falling within the scope of the disclosed forms. The appended claims are intended to cover all such modifications, variations, changes, substitutions, modifications, and equivalents.

The foregoing detailed description has set forth various forms of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, and/or examples can be implemented, individually and/or collectively, by a wide range of hardware, software, firmware, or virtually any combination thereof. Those skilled in the art will recognize that some aspects of the forms disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. It may be understood that one or more computers may refer to any electronic device having a processor or microprocessor and memory devices in which software may be stored and executed to cause the intended result. Thus, in this sense, such computers may also include desktop computers, laptop computers, tablet computers, or any mobile device (including, but not limited to cell phones and smart phones) having the microprocessor and memory devices capable of executing such software instructions. In addition, those skilled in the art will appreciate that the mechanisms of the subject matter described herein are capable of being distributed as one or more program products in a variety of forms, and that an illustrative form of the subject matter described herein applies regardless of the particular type of signal bearing medium used to actually carry out the distribution.

Instructions used to program logic to perform various disclosed aspects can be stored within a memory in the system, such as dynamic random access memory (DRAM), cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, compact disc, read-only memory (CD-ROMs), and magneto-optical disks, read-only memory (ROMs), random access memory (RAM), erasable programmable read-only memory (EPROM), electrically erasable programmable read-only memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the non-transitory computer-readable medium includes any type of tangible machine-readable medium suitable for storing or transmitting electronic instructions or information in a form readable by a machine (e.g., a computer).

As used in any aspect herein, the term “control circuit” may refer to, for example, hardwired circuitry, programmable circuitry (e.g., a computer processor comprising one or more individual instruction processing cores, processing unit, processor, microcontroller, microcontroller unit, controller, digital signal processor (DSP), programmable logic device (PLD), programmable logic array (PLA), or field programmable gate array (FPGA)), state machine circuitry, firmware that stores instructions executed by programmable circuitry, and any combination thereof. The control circuit may, collectively or individually, be embodied as circuitry that forms part of a larger system, for example, an integrated circuit (IC), an application-specific integrated circuit (ASIC), a system on-chip (SoC), desktop computers, laptop computers, tablet computers, servers, smart phones, etc. Accordingly, as used herein “control circuit” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

As used in any aspect herein, the term “logic” may refer to an app, software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

As used in any aspect herein, the terms “component,” “system,” “module” and the like can refer to a computer-related entity, either hardware, a combination of hardware and software, software, or software in execution.

As used in any aspect herein, an “algorithm” refers to a self-consistent sequence of steps leading to a desired result, where a “step” refers to a manipulation of physical quantities and/or logic states which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities and/or states.

A network may include a packet switched network. The communication devices may be capable of communicating with each other using a selected packet switched network communications protocol. One example communications protocol may include an Ethernet communications protocol which may be capable permitting communication using a Transmission Control Protocol/Internet Protocol (TCP/IP). The Ethernet protocol may comply or be compatible with the Ethernet standard published by the Institute of Electrical and Electronics Engineers (IEEE) titled “IEEE 802.3 Standard”, published in December, 2008 and/or later versions of this standard. Alternatively or additionally, the communication devices may be capable of communicating with each other using an X.25 communications protocol. The X.25 communications protocol may comply or be compatible with a standard promulgated by the International Telecommunication Union-Telecommunication Standardization Sector (ITU-T). Alternatively or additionally, the communication devices may be capable of communicating with each other using a frame relay communications protocol. The frame relay communications protocol may comply or be compatible with a standard promulgated by Consultative Committee for International Telegraph and Telephone (CCITT) and/or the American National Standards Institute (ANSI). Alternatively or additionally, the transceivers may be capable of communicating with each other using an Asynchronous Transfer Mode (ATM) communications protocol. The ATM communications protocol may comply or be compatible with an ATM standard published by the ATM Forum titled “ATM-MPLS Network Interworking 2.0” published August 2001, and/or later versions of this standard. Of course, different and/or after-developed connection-oriented network communication protocols are equally contemplated herein.

Unless specifically stated otherwise as apparent from the foregoing disclosure, it is appreciated that, throughout the foregoing disclosure, discussions using terms such as “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

One or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flow diagrams are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” “an example,” “one example,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

In summary, numerous benefits have been described which result from employing the concepts described herein. The foregoing description of the one or more forms has been presented for purposes of illustration and description. It is not intended to be exhaustive or limiting to the precise form disclosed. Modifications or variations are possible in light of the above teachings. The one or more forms were chosen and described in order to illustrate principles and practical application to thereby enable one of ordinary skill in the art to utilize the various forms and with various modifications as are suited to the particular use contemplated. It is intended that the claims submitted herewith define the overall scope.

Various aspects of the subject matter described herein are set out in the following numbered examples:

### Example 1

A system for determining a presence of a mobile device located in a predetermined detection zone within a vehicle, the system comprising:
a plurality of transmitters located within the vehicle, wherein each of the plurality of transmitters is configured to transmit a ranging acoustic signal, wherein the ranging acoustic signal comprises at least one predetermined ranging acoustic signal characteristic;
a mobile device configured to receive each ranging acoustic signal transmitted by the plurality of transmitters; and
a processor configured to:
   determine a location of the mobile device within the vehicle based on the ranging acoustic signals transmitted by the plurality of transmitters and received by the mobile device;
   determine when the location of the mobile device matches the predetermined detection zone; and
   cause the mobile device to inhibit at least one function of the mobile device upon determining that the location of the mobile device matches the predetermined detection zone; and
   wherein the mobile device is configured to identify the ranging acoustic signal based at least in part on the at least one predetermined ranging acoustic signal characteristic.

### Example 2

The system of Example 1, wherein the predetermined detection zone is a three dimensional area at, around, or proximal to a driver's side or seat of a vehicle.

### Example 3

The system of any one or more of Examples 1 through 2, wherein in the predetermined detection zone is a three dimensional area at or near a passenger seat.

### Example 4

The system of any one or more of Examples 1 through 3, wherein the ranging acoustic signal comprises a linear chirp signal.

### Example 5

The system of any one or more of Examples 1 through 4, wherein the ranging acoustic signal comprises a non-linear chirp signal.

### Example 6

The system of any one or more of Examples 1 through 5, wherein the mobile device is configured to identify the ranging acoustic signal using a matching filter.

### Example 7

A method for determining a presence of a mobile device located in a predetermined detection zone within a vehicle, the method comprising:
transmitting, by each of a plurality of transmitters located within the vehicle, a ranging acoustic signal to the mobile device, wherein the ranging acoustic signal comprises at least one predetermined ranging acoustic signal characteristic;
receiving, by the mobile device, each ranging acoustic signal transmitted by the plurality of transmitters;
identifying, by the mobile device, each ranging acoustic signal according to the at least one predetermined ranging acoustic signal characteristic;
determining, by a processor, a location of the mobile device within the vehicle based on the ranging acoustic signals transmitted by the plurality of transmitters and received by the mobile device when the ranging acoustic signals are identified by the mobile device as having the at least one predetermined ranging acoustic signal characteristic; and
determining that the location of the mobile device matches the predetermined detection zone.

### Example 8

The method of Example 7, further comprising inhibiting at least one function of the mobile device upon determining that the location of the mobile device matches the predetermined detection zone;
wherein the predetermined detection zone is a three dimensional area at, around, or proximal to a driver's side or seat of a vehicle,
and wherein each of the ranging acoustic signals comprises at least one ultrasonic pulse having a frequency in a range of 16 KHz to 26 KHz.

### Example 9

The method of any one or more of Examples 7 through 8 further comprising inhibiting at least one function of the mobile device upon determining that the location of the mobile device matches the predetermined detection zone;
wherein the predetermined detection zone is a three dimensional area at, around, or proximal to a driver's side or seat of a vehicle,
and wherein each of the ranging acoustic signals comprises at least one ultrasonic pulse at 19 kHz.

### Example 10

The method of any one or more of Examples 7 through 9, wherein transmitting a ranging acoustic signal to the mobile device, wherein the ranging acoustic signal comprises at least one predetermined ranging acoustic signal characteristic comprises transmitting a ranging acoustic signal to the mobile device, wherein the ranging acoustic signal comprises a linear chirp signal.

### Example 11

The method of any one or more of Examples 7 through 10, wherein transmitting, a ranging acoustic signal to the mobile device, wherein the ranging acoustic signal comprises at least one predetermined ranging acoustic signal characteristic comprises transmitting, a ranging acoustic signal to the mobile device, wherein the ranging acoustic signal comprises a non-linear chirp signal.

### Example 12

The method of any one or more of Examples 7 through 11, wherein identifying, by the mobile device, each ranging acoustic signal according to the at least one predetermined ranging acoustic signal characteristic comprises filtering, by the mobile device, each ranging acoustic signal according to a filter having filter characteristics that match the at least one predetermined ranging acoustic signal characteristic.

### Example 13

A method of controlling the use of a software application by a user of a mobile device located within a vehicle, the method comprising:
configuring the mobile device to permit or restrict the use of the software application by the user when the mobile device is located within a pre-determined detection zone within the vehicle;
transmitting, by each of a plurality of transmitters located within the vehicle, a ranging acoustic signal to the mobile device, wherein the ranging acoustic signal comprises at least one predetermined ranging acoustic signal characteristic;
receiving, by the mobile device, each ranging acoustic signal transmitted by the plurality of transmitters;
identifying, by the mobile device, each ranging acoustic signal according to the at least one predetermined ranging acoustic signal characteristic;
determining, by a processor, a location of the mobile device within the vehicle based on the ranging acoustic signals transmitted by the plurality of transmitters and received by the mobile device when the ranging acoustic signals are identified by the mobile device as having the at least one predetermined ranging acoustic signal characteristic;
determining that the location of the mobile device matches the predetermined detection zone; and
permitting or restricting the use of the software application by the user when the location of the mobile device matches the pre-determined detection zone.

### Example 14

The method of Example 13, wherein configuring the mobile device to permit or restrict the use of the software application by the user comprises configuring the mobile device to permit or restrict the use of one or more of a telephone application, a texting application, a web browser application, a video streaming application, a video conferencing application, and a navigation application.

### Example 15

The method of any one or more of Examples 13 through 14, wherein configuring the mobile device to permit or restrict the use of the software application by the user when the mobile device is located within a pre-determined detection zone within the vehicle comprises configuring the mobile device to restrict the use of the software application by the user when the mobile device is located within a pre-determined detection zone comprising a three dimensional area surrounding or proximate to the driver's seat in the vehicle, and wherein permitting or restricting the use of the software application by the user when the location of the mobile device matches the pre-determined detection zone comprises restricting the use of the software application by the user when the location of the mobile device matches the pre-determined detection zone comprising a three dimensional area surrounding or proximate to the driver's seat in the vehicle.

### Example 16

The method of any one or more of Examples 13 through 15, wherein configuring the mobile device to permit or restrict the use of the software application by the user when the mobile device is located within a pre-determined detection zone within the vehicle comprises configuring the mobile device to permit the use of the software application by the user when the mobile device is located within a pre-determined detection zone comprising a three dimensional area surrounding or proximate to a passenger's seat in the vehicle, and
wherein permitting or restricting the use of the software application by the user when the location of the mobile device matches the pre-determined detection zone comprises permitting the use of the software application by the user when the location of the mobile device matches the pre-determined detection zone comprising a three dimensional area surrounding or proximate to the passenger's seat in the vehicle.

### Example 17

The method of any one or more of Examples 13 through 16, wherein configuring the mobile device to permit or restrict the use of the software application by the user comprises configuring the mobile device to permit or restrict the use of the software application by entering configuration data through a graphical user interface displayed on the mobile device.

### Example 18

The method of Example 17, wherein configuring the mobile device to permit or restrict the use of the software application by entering configuration data through a graphical user interface displayed on the mobile device comprises configuring the mobile device to permit or restrict the use of the software application by entering configuration data through a graphical user interface displayed on the mobile device by one or more individuals having appropriate programming privileges.

### Example 19

The method of any one or more of claims 17 through 18, wherein configuring the mobile device to permit or restrict the use of the software application by entering configuration data through a graphical user interface displayed on the mobile device comprises configuring the mobile device to permit or restrict the use of the software application by entering configuration data through a graphical user interface displayed on the mobile device wherein the graphical user interface includes indicia of one or more software applications and indicia of one or more zones within the vehicle.

What is claimed is:

1. A system for determining a presence of a mobile device located in a predetermined detection zone within a vehicle, the system comprising:
a plurality of transmitters located within the vehicle, wherein each of the plurality of transmitters is configured to transmit a ranging acoustic signal, wherein the ranging acoustic signal comprises at least one predetermined ranging acoustic signal characteristic;
a mobile device configured to receive each ranging acoustic signal transmitted by the plurality of transmitters; and
a processor configured to:
determine a location of the mobile device within the vehicle based on the ranging acoustic signals transmitted by the plurality of transmitters and received by the mobile device;
determine when the location of the mobile device matches the predetermined detection zone; and
cause the mobile device to inhibit at least one function of the mobile device upon determining that the location of the mobile device matches the predetermined detection zone; and
wherein the mobile device is configured to identify the ranging acoustic signal based at least in part on the at least one predetermined ranging acoustic signal characteristic.

2. The system of claim 1, wherein the predetermined detection zone is a three dimensional area at, around, or proximal to a driver's side or seat of a vehicle.

3. The system of claim 1, wherein in the predetermined detection zone is a three dimensional area at or near a passenger seat.

4. The system of claim 1, wherein the ranging acoustic signal comprises a linear chirp signal.

5. The system of claim 1, wherein the ranging acoustic signal comprises a non-linear chirp signal.

6. The system of claim 1, wherein the mobile device is configured to identify the ranging acoustic signal using a matching filter.

7. A method for determining a presence of a mobile device located in a predetermined detection zone within a vehicle, the method comprising:
transmitting, by each of a plurality of transmitters located within the vehicle, a ranging acoustic signal to the mobile device, wherein the ranging acoustic signal comprises at least one predetermined ranging acoustic signal characteristic;
receiving, by the mobile device, each ranging acoustic signal transmitted by the plurality of transmitters;
identifying, by the mobile device, each ranging acoustic signal according to the at least one predetermined ranging acoustic signal characteristic;
determining, by a processor, a location of the mobile device within the vehicle based on the ranging acoustic signals transmitted by the plurality of transmitters and received by the mobile device when the ranging acoustic signals are identified by the mobile device as having the at least one predetermined ranging acoustic signal characteristic; and
determining that the location of the mobile device matches the predetermined detection zone.

8. The method of claim 7, further comprising inhibiting at least one function of the mobile device upon determining that the location of the mobile device matches the predetermined detection zone;
wherein the predetermined detection zone is a three dimensional area at, around, or proximal to a driver's side or seat of a vehicle,
and wherein each of the ranging acoustic signals comprises at least one ultrasonic pulse having a frequency in a range of 16 KHz to 26 KHz.

9. The method of claim 7 further comprising inhibiting at least one function of the mobile device upon determining that the location of the mobile device matches the predetermined detection zone;
wherein the predetermined detection zone is a three dimensional area at, around, or proximal to a driver's side or seat of a vehicle,
and wherein each of the ranging acoustic signals comprises at least one ultrasonic pulse at 19 kHz.

10. The method of claim 7, wherein transmitting, a ranging acoustic signal to the mobile device, wherein the ranging acoustic signal comprises at least one predetermined ranging acoustic signal characteristic comprises transmitting a ranging acoustic signal to the mobile device, wherein the ranging acoustic signal comprises a linear chirp signal.

11. The method of claim 7, wherein transmitting, a ranging acoustic signal to the mobile device, wherein the ranging acoustic signal comprises at least one predetermined ranging acoustic signal characteristic comprises transmitting, a ranging acoustic signal to the mobile device, wherein the ranging acoustic signal comprises a non-linear chirp signal.

12. The method of claim 7, wherein identifying, by the mobile device, each ranging acoustic signal according to the at least one predetermined ranging acoustic signal characteristic comprises filtering, by the mobile device, each ranging acoustic signal according to a filter having filter characteristics that match the at least one predetermined ranging acoustic signal characteristic.

13. A method of controlling the use of a software application by a user of a mobile device located within a vehicle, the method comprising:
configuring the mobile device to permit or restrict the use of the software application by the user when the mobile device is located within a pre-determined detection zone within the vehicle;
transmitting, by each of a plurality of transmitters located within the vehicle, a ranging acoustic signal to the mobile device, wherein the ranging acoustic signal comprises at least one predetermined ranging acoustic signal characteristic;
receiving, by the mobile device, each ranging acoustic signal transmitted by the plurality of transmitters;
identifying, by the mobile device, each ranging acoustic signal according to the at least one predetermined ranging acoustic signal characteristic;
determining, by a processor, a location of the mobile device within the vehicle based on the ranging acoustic signals transmitted by the plurality of transmitters and received by the mobile device when the ranging acoustic signals are identified by the mobile device as having the at least one predetermined ranging acoustic signal characteristic;
determining that the location of the mobile device matches the predetermined detection zone; and
permitting or restricting the use of the software application by the user when the location of the mobile device matches the pre-determined detection zone.

14. The method of claim 13, wherein configuring the mobile device to permit or restrict the use of the software application by the user comprises configuring the mobile device to permit or restrict the use of one or more of a telephone application, a texting application, a web browser application, a video streaming application, a video conferencing application, and a navigation application.

15. The method of claim 13, wherein configuring the mobile device to permit or restrict the use of the software application by the user when the mobile device is located within a pre-determined detection zone within the vehicle comprises configuring the mobile device to restrict the use of the software application by the user when the mobile device is located within a pre-determined detection zone comprising a three dimensional area surrounding or proximate to the driver's seat in the vehicle, and
wherein permitting or restricting the use of the software application by the user when the location of the mobile device matches the pre-determined detection zone comprises restricting the use of the software application by the user when the location of the mobile device matches the pre-determined detection zone comprising a three dimensional area surrounding or proximate to the driver's seat in the vehicle.

16. The method of claim 13, wherein configuring the mobile device to permit or restrict the use of the software application by the user when the mobile device is located within a pre-determined detection zone within the vehicle comprises configuring the mobile device to permit the use of the software application by the user when the mobile device is located within a pre-determined detection zone comprising a three dimensional area surrounding or proximate to a passenger's seat in the vehicle, and
wherein permitting or restricting the use of the software application by the user when the location of the mobile device matches the pre-determined detection zone comprises permitting the use of the software application by the user when the location of the mobile device matches the pre-determined detection zone comprising a three dimensional area surrounding or proximate to the passenger's seat in the vehicle.

17. The method of claim 13, wherein configuring the mobile device to permit or restrict the use of the software application by the user comprises configuring the mobile device to permit or restrict the use of the software application by entering configuration data through a graphical user interface displayed on the mobile device.

18. The method of claim 17, wherein configuring the mobile device to permit or restrict the use of the software application by entering configuration data through a graphical user interface displayed on the mobile device comprises configuring the mobile device to permit or restrict the use of the software application by entering configuration data through a graphical user interface displayed on the mobile device by one or more individuals having appropriate programming privileges.

19. The method of claim 17, wherein configuring the mobile device to permit or restrict the use of the software application by entering configuration data through a graphical user interface displayed on the mobile device comprises configuring the mobile device to permit or restrict the use of the software application by entering configuration data through a graphical user interface displayed on the mobile device wherein the graphical user interface includes indicia of one or more software applications and indicia of one or more zones within the vehicle.
